(19) United States
(12) Patent Application Publication
(10) Pub. No.: US 2023/0110602 A1
(43) Pub. Date: Apr. 13, 2023

(54) FEDERATED LEARNING MODEL LINEAGE

(71) Applicant: International Business Machines Corporation, Armonk, NY (US)

(72) Inventors: Mark Purcell, Naas (IE); Ambrish Rawat, Dublin (IE); Stefano Braghin, Dublin (IE)

(21) Appl. No.: 17/450,709

(22) Filed: Oct. 13, 2021

(51) Int. Cl. G06N 20/00

(52) U.S. Cl. CPC G06N 20/00

(57) ABSTRACT

A computer-implemented method, a computer program product, and a computer system for federated learning model lineage. A model lineage system receives an initial model, from an aggregator in a federated learning system, where the aggregator starts a round of training the initial model. The model lineage system dispatches the initial model to workers in the federated learning system. The model lineage system records the initial model in a lineage database. The model lineage system receives updates from the workers which train the initial model locally. The model lineage system records the updates in the lineage database.

### BACKGROUND

The present invention relates generally to federated learning, and more particularly to federated learning model lineage.

In general, a federated learning system performs data analytics or model training across a distributed set of clients which do not share data. In the federated learning system, in the beginning, a federated learning plan is laid out that specifies the necessary details for training an initial machine learning model. The federated learning plan may include details of client participation, optimization parameters, parameters for aggregation protocols, etc. After local training, participants or clients provide updates (e.g., model weights) to an aggregator, who fuses these updates from all participants or clients to create a new machine learning model.

### SUMMARY

In one aspect, a computer-implemented method for federated learning model lineage is provided. The computer-implemented method includes receiving, by a model lineage system, an initial model, from an aggregator in a federated learning system, where the aggregator starts a round of training the initial model. The computer-implemented method further includes dispatching, by the model lineage system, the initial model to workers in the federated learning system. The computer-implemented method further includes recording, by the model lineage system, the initial model in a lineage database. The computer-implemented method further includes receiving, by the model lineage system, updates from the workers which train the initial model locally. The computer-implemented method further includes recording, by the model lineage system, the updates in the lineage database.

In another aspect, a computer program product for federated learning model lineage is provided. The computer program product comprises a computer readable storage medium having program instructions embodied therewith, and the program instructions are executable by one or more processors. The program instructions are executable to: receive, by a model lineage system, an initial model, from an aggregator in a federated learning system, where the aggregator starts a round of training the initial model; dispatch, by the model lineage system, the initial model to workers in the federated learning system; record, by the model lineage system, the initial model in a lineage database; receive, by the model lineage system, updates from the workers which train the initial model locally; and record, by the model lineage system, the updates in the lineage database.

In yet another aspect, a computer system for federated learning model lineage is provided. The computer system comprises one or more processors, one or more computer readable tangible storage devices, and program instructions stored on at least one of the one or more computer readable tangible storage devices for execution by at least one of the one or more processors. The program instructions are executable to receive, by a model lineage system, an initial model, from an aggregator in a federated learning system, where the aggregator starts a round of training the initial model. The program instructions are further executable to dispatch, by the model lineage system, the initial model to workers in the federated learning system. The program instructions are further executable to record, by the model lineage system, the initial model in a lineage database. The program instructions are further executable to receive, by the model lineage system, updates from the workers which train the initial model locally. The program instructions are further executable to record, by the model lineage system, the updates in the lineage database.

### BRIEF DESCRIPTION OF THE SEVERAL VIEWS OF THE DRAWINGS

FIG. 1 is a systematic diagram illustrating a general federated learning system.

FIG. 2 is a systematic diagram illustrating a federated learning system with a model lineage sub-system, in accordance with one embodiment of the present invention.

FIG. 3 is a flowchart showing operational steps of federated learning model lineage, in accordance with one embodiment of the present invention.

FIG. 4 is a diagram illustrating components of a computing device or server, in accordance with one embodiment of the present invention.

FIG. 5 depicts a cloud computing environment, in accordance with one embodiment of the present invention.

FIG. 6 depicts abstraction model layers in a cloud computing environment, in accordance with one embodiment of the present invention.

### DETAILED DESCRIPTION

Embodiments of the present invention disclose a system that records model weights and interim models by contributors. The system can retrospectively provide a full lineage of a complete model, identify each model update corresponding to each contributor, provide an audit trail for compliance procedures, allow for checkpointing of the modelling process, and enable downstream analytics/modelling to learn from the learning process.

In the present invention, the disclosed system monitors the federated learning process in real time, records the contributions from all engaged parties, logs every communication exchange, and results in a full lineage or ancestry of a final model.

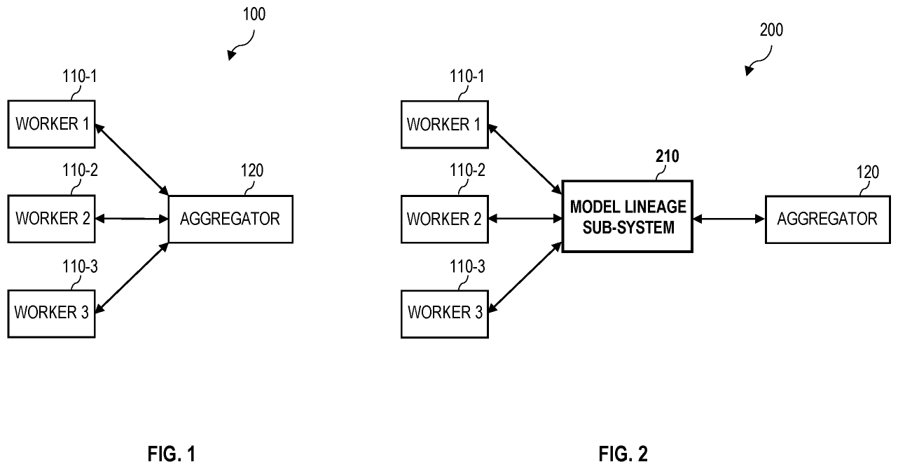

FIG. 1 is a systematic diagram illustrating general federated learning system 100. General federated learning system 100 includes multiple workers; for the purpose of illustrating an example, three workers (namely worker 1 110-1, worker 2 110-2, and worker 3 110-3) are illustrated in FIG. 1. General federated learning system 100 further includes aggregator 120. In the example shown in FIG. 1, worker 1 110-1, worker 2 110-2, and worker 3 110-3 train an initial machine learning model and provide updates (e.g., model weights) to aggregator 120; aggregator 120 fuses the updates to create a new machine learning model.

FIG. 2 is a systematic diagram illustrating federated learning system 200 with model lineage sub-system 210, in accordance with one embodiment of the present invention. Model lineage sub-system 210 in the present invention includes a routing mechanism and a checkpointing module that together enable a lineage service. In the example shown in FIG. 2, model lineage sub-system 210 is added into an existing federated learning system (including worker 1 110-1, worker 2 110-2, worker 3 110-3, and aggregator 120), being situated between workers (worker 1 110-1, worker 2 110-2, and worker 3 110-3) and aggregator 120.

Model lineage sub-system 210 plays a role of routing for multi-party communication between the workers (worker 1 110-1, worker 2 110-2, and worker 3 110-3) and aggregator 120. The checkpointing module in model lineage sub-system 210 receives the following as input: interim or final models from aggregator 120; model updates from worker 1 110-1, worker 2 110-2, worker 3 110-3. The input of the checkpointing module further includes user IDs (identifications) of contributors (including the aggregator and the workers) and storage locations or IDs of the individual models or model updates. Based on the input, the checkpointing module in model lineage sub-system 210 generates output: individual records of each stage of the federated learning process. Model lineage sub-system 210 records or checkpoints the input and the output in a lineage database.

In one embodiment, an integrated checkpointing module in model lineage sub-system 210 is a plugin to an existing federated learning system (including worker 1 110-1, worker 2 110-2, worker 3 110-3, and aggregator 120). The checkpointing module is integrated with the existing federated learning system.

In another embodiment, the checkpointing module in model lineage sub-system 210 is invoked on demand by an existing federated learning system. Model lineage sub-system 210 presents an API (application programming interface) to the federated learning system to manually invoke recording model lineage.

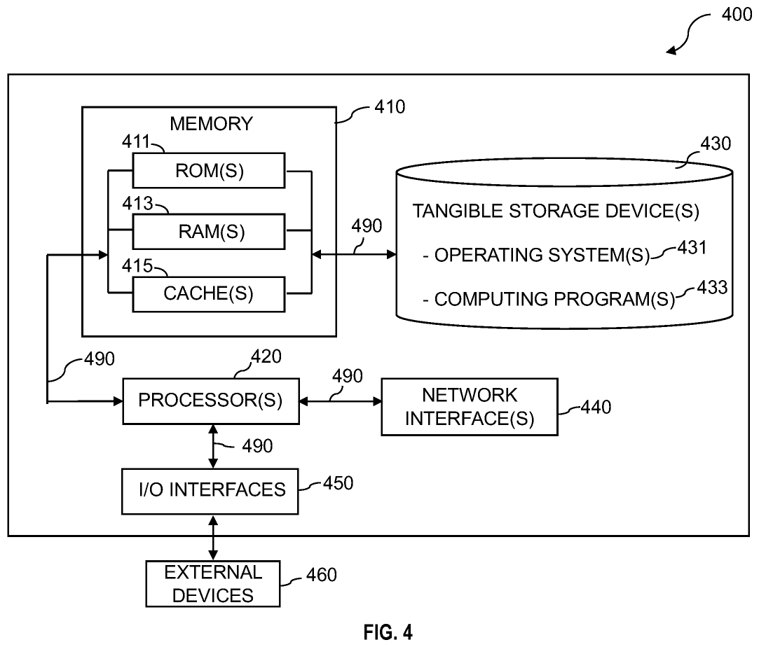

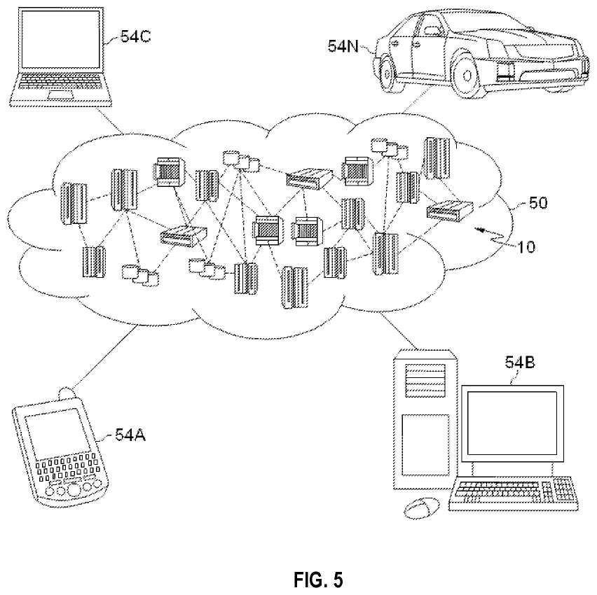

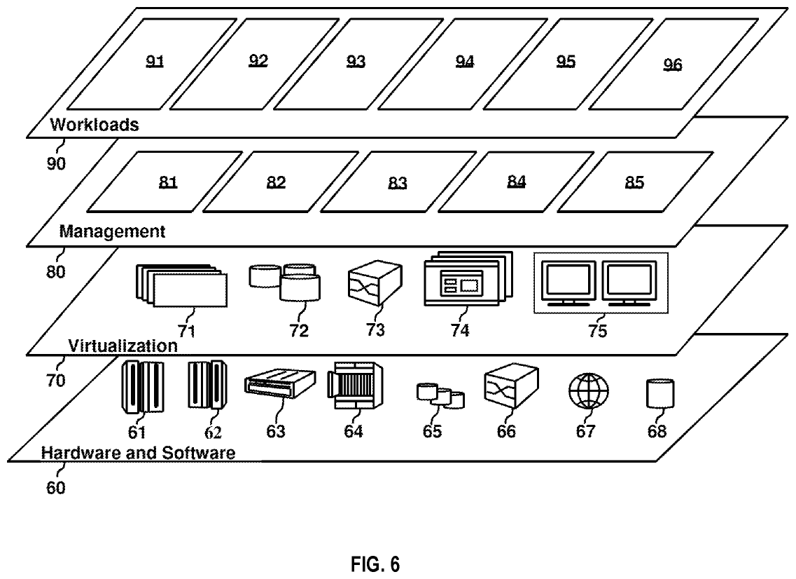

Federated learning system 200 with model lineage sub-system 210 is implemented on one or more computing devices or servers. A computing device or server is described in more detail in later paragraphs with reference to FIG. 4. Federated learning system 200 with model lineage sub-system 210 may be implemented in a cloud computing environment. The cloud computing environment is described in more detail in later paragraphs with reference to FIG. 5 and FIG. 6.

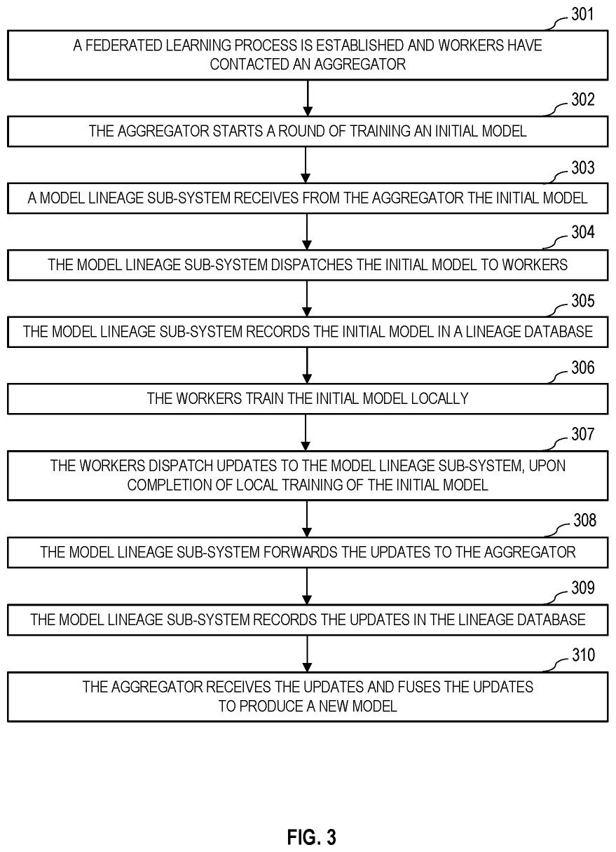

FIG. 3 is a flowchart showing operational steps of federated learning model lineage, in accordance with one embodiment of the present invention. At step 301, a federated learning process is established and workers have contacted an aggregator. In the example shown in FIG. 2, the federated learning process is established in federated learning system 200 including worker 1 110-1, worker 2 110-2, worker 3 110-3, and aggregator 120. At step 302, the aggregator starts a round of training an initial model. In the example shown in FIG. 2, aggregator 120 in federated learning system 200 starts a round of training the initial model.

At step 303, a model lineage sub-system receives from the aggregator the initial model. The aggregator broadcasts the initial model to the workers through the model lineage sub-system, using the routing mechanism in the present invention. In the example shown in FIG. 2, model lineage sub-system 210, which is added into the existing federated learning system, plays a role of routing for multi-party communication between the workers and the aggregator; model lineage sub-system 210 receives the initial model from aggregator 120.

At step 304, the model lineage sub-system dispatches the initial model to workers. Using the routing mechanism in the present invention, after receiving the broadcasting of the initial model, the model lineage sub-system sends the initial model to workers. In the example shown in FIG. 2, model lineage sub-system 210 dispatches the initial model to worker 1 110-1, worker 2 110-2, and worker 3 110-3.

At step 305, the model lineage sub-system records the initial model in a lineage database. If a checkpointing module in the model lineage sub-system is instantiated, the initial model received from the aggregator is recorded (or checkpointed) in the lineage database. In one embodiment, the checkpointing module may be instantiated as an integrated checkpointing module and as a plugin to an existing federated learning system; in another embodiment, the checkpointing module may be instantiated as a manual checkpointing module which may be invoked on demand by an existing federated learning system. In the example shown in FIG. 2, the checkpointing module in model lineage sub-system 210, if instantiated, records the initial model in the lineage database.

At step 306, the workers train the initial model locally. In the example shown in FIG. 2, each of worker 1 110-1, worker 2 110-2, and worker 3 110-3 trains the initial model locally. At step 307, upon completion of local training of the initial model, each of the workers dispatches updates to the model lineage sub-system. In the example shown in FIG. 2, each of worker 1 110-1, worker 2 110-2, and worker 3 110-3 sends the updates of the trained model to model lineage sub-system 210.

At step 308, the model lineage sub-system forwards the updates to the aggregator. After the model lineage sub-system receives the updates dispatched by the workers at step 307, the model lineage sub-system sends each update to the aggregator. In the example shown in FIG. 2, model lineage sub-system 210 receives the updates from worker 1 110-1, worker 2 110-2, and worker 3 110-3, and then model lineage sub-system 210 sends the updates to aggregator 120.

At step 309, the model lineage sub-system records the updates in the lineage database. If a checkpointing module in the model lineage sub-system is instantiated, the updates received from the workers is recorded (or checkpointed) in the lineage database. In the example shown in FIG. 2, model lineage sub-system 210 records the updates received from worker 1 110-1, worker 2 110-2, and worker 3 110-3.

At step 310, the aggregator receives the updates and fuses the updates to produce a new model. The aggregator receives the updates forwarded by the model lineage sub-system at step 308. After fusing the updates, the aggregator broadcasts the fused updates to the clients for further training (or training the new model). In the federated learning process, the aggregator fuses the updates. In the example shown in FIG. 2, aggregator 120 receives the updates forwarded by model lineage sub-system 210 and fuses the updates.

FIG. 4 is a diagram illustrating components of computing device or server 400, in accordance with one embodiment of the present invention. It should be appreciated that FIG. 4 provides only an illustration of one implementation and does not imply any limitations with regard to the environment in which different embodiments may be implemented.

Referring to FIG. 4, computing device or server 400 includes processor(s) 420, memory 410, and tangible storage device(s) 430. In FIG. 4, communications among the above-mentioned components of computing device or server 400 are denoted by numeral 490. Memory 410 includes ROM(s) (Read Only Memory) 411, RAM(s) (Random Access Memory) 413, and cache(s) 415. One or more operating systems 431 and one or more computer programs 433 reside on one or more computer readable tangible storage device(s) 430.

Computing device or server 400 further includes I/O interface(s) 450. I/O interface(s) 450 allows for input and output of data with external device(s) 460 that may be connected to computing device or server 400. Computing device or server 400 further includes network interface(s) 440 for communications between computing device or server 400 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality of federated learning model lineage.

What is claimed is:

1. A computer-implemented method for federated learning model lineage, the method comprising:
receiving, by a model lineage system, an initial model, from an aggregator in a federated learning system, wherein the aggregator starts a round of training the initial model;
dispatching, by the model lineage system, the initial model to workers in the federated learning system;
recording, by the model lineage system, the initial model in a lineage database;
receiving, by the model lineage system, updates from the workers which train the initial model locally; and
recording, by the model lineage system, the updates in the lineage database.

2. The computer-implemented method of claim 1, further comprising:
forwarding, by the model lineage system, the updates to the aggregator.

3. The computer-implemented method of claim 1, further comprising:
training, by the workers, the initial model locally, in response to receiving from the model lineage system the initial model; and
dispatching, by the workers, the updates to the model lineage system, in response to completion of local training of the initial model.

4. The computer-implemented method of claim 1, further comprising:
receiving, by the aggregator, the updates from the model lineage system; and
fusing, by the aggregator, the updates to produce a new model.

5. The computer-implemented method of claim 1, wherein the model lineage system is integrated into the federated learning system.

6. The computer-implemented method of claim 1, wherein model lineage system is invoked on demand by the federated learning system.

7. The computer-implemented method of claim 6, wherein the model lineage system presents an application programming interface (API) to the federated learning system to manually invoke recording model lineage.

8. A computer program product for federated learning model lineage, the computer program product comprising a computer readable storage medium having program instructions embodied therewith, the program instructions executable by one or more processors, the program instructions executable to:
receive, by a model lineage system, an initial model, from an aggregator in a federated learning system, wherein the aggregator starts a round of training the initial model;
dispatch, by the model lineage system, the initial model to workers in the federated learning system;
record, by the model lineage system, the initial model in a lineage database;
receive, by the model lineage system, updates from the workers which train the initial model locally; and
record, by the model lineage system, the updates in the lineage database.

9. The computer program product of claim 8, further comprising the program instructions executable to:
forward, by the model lineage system, the updates to the aggregator.

10. The computer program product of claim 8, further comprising the program instructions executable to:
train, by the workers, the initial model locally, in response to receiving from the model lineage system the initial model; and
dispatch, by the workers, the updates to the model lineage system, in response to completion of local training of the initial model.

11. The computer program product of claim 8, further comprising the program instructions executable to:
receive, by the aggregator, the updates from the model lineage system; and
fuse, by the aggregator, the updates to produce a new model.

12. The computer program product of claim 8, wherein the model lineage system is integrated into the federated learning system.

13. The computer program product of claim 8, wherein model lineage system is invoked on demand by the federated learning system.

14. The computer program product of claim 13, wherein the model lineage system presents an application programming interface (API) to the federated learning system to manually invoke recording model lineage.

15. A computer system for federated learning model lineage, the computer system comprising:
one or more processors, one or more computer readable tangible storage devices, and program instructions stored on at least one of the one or more computer readable tangible storage devices for execution by at least one of the one or more processors, the program instructions executable to:
receive, by a model lineage system, an initial model, from an aggregator in a federated learning system, wherein the aggregator starts a round of training the initial model;
dispatch, by the model lineage system, the initial model to workers in the federated learning system;
record, by the model lineage system, the initial model in a lineage database;
receive, by the model lineage system, updates from the workers which train the initial model locally; and
record, by the model lineage system, the updates in the lineage database.

16. The computer system of claim 15, further comprising the program instructions executable to:
forward, by the model lineage system, the updates to the aggregator.

17. The computer system of claim 15, further comprising the program instructions executable to:
train, by the workers, the initial model locally, in response to receiving from the model lineage system the initial model; and
dispatch, by the workers, the updates to the model lineage system, in response to completion of local training of the initial model.

18. The computer system of claim 15, further comprising the program instructions executable to:
receive, by the aggregator, the updates from the model lineage system; and
fuse, by the aggregator, the updates to produce a new model.

19. The computer system of claim 15, wherein the model lineage system is integrated into the federated learning system.

20. The computer system of claim 15, wherein model lineage system is invoked on demand by the federated learning system, wherein the model lineage system presents an application programming interface (API) to the federated learning system to manually invoke recording model lineage.
